(19) United States
(12) Patent Application Publication
(10) Pub. No.: US 2016/0047531 A1
(43) Pub. Date: Feb. 18, 2016

(54) LIGHTING DEVICE AND LUMINAIRE

(71) Applicant: KONINKLIJKE PHILIPS N.V., Eindhoven (NL)

(72) Inventors: Ya-Kuang HSIAO, Sindian City (TW); Lei SUI, Shanghai (CN); Zhiquan CHEN, Shanghai (CN); Huaizhou LIAO, Shanghai (CN); Feng HE, Shanghai (CN)

(21) Appl. No.: 14/780,008

(22) PCT Filed: Mar. 18, 2014
(86) PCT No.: PCT/IB2014/059940

§ 371 Date: Sep. 25, 2015

(30) Foreign Application Priority Data
Mar. 26, 2013 (CN) PCT/CN2013/073171

(51) Int. Cl. F21V 7/08; F21V 7/06; F21V 7/00

(52) U.S. Cl. CPC F21V 7/08; F21V 7/0008; F21V 7/06; F21Y 2101/02

(57) ABSTRACT

Disclosed is a lighting device including a reflective element (10) comprising a reflective conical central section (12) having a conic constant in the range of −0.7 to −1.3; and an annular array of reflective ellipsoid surfaces (14, 14′) extending radially from said reflective conical central section, each reflective ellipsoid surface creating a first focal point (16) inside the reflective conical central section and a second focal point. The lighting device further comprises a solid state lighting element (20, 20′) located at the second focal point of each of said reflective ellipsoid surfaces and arranged to emit light towards said reflective ellipsoid surface; and an exit window (30) opposite said reflective conical central section. A luminaire including such a lighting device is also disclosed.

### FIELD OF THE INVENTION

The present invention relates to a lighting device comprising an array of reflective ellipsoid surfaces, each reflective ellipsoid surface creating a first focal point and a second focal point and a solid state lighting element located at the second focal point of each of said reflective ellipsoid surfaces and arranged to emit light towards said reflective ellipsoid surface.

The present invention further relates to a luminaire comprising such a lighting device.

### BACKGROUND OF THE INVENTION

With a continuously growing population, it is becoming increasingly difficult to meet the world's energy needs as well as to control carbon emissions to kerb greenhouse gas emissions that are considered responsible for global warming phenomena. These concerns have triggered a drive towards more efficient energy consumption in an attempt to reduce energy consumption.

One such area of concern is lighting applications, either in domestic or commercial settings. There is a clear trend towards the replacement of traditional incandescent light bulbs, which are notoriously energy inefficient, with more energy efficient replacements. Indeed, in many jurisdictions the production and retailing of incandescent light bulbs has been outlawed, thus forcing consumers to buy energy-efficient alternatives, e.g. when replacing incandescent light bulbs.

A particular promising alternative is provided by solid state lighting (SSL) devices, which can produce a unit luminous output at a fraction of the energy cost of incandescent light bulbs. An example of such a SSL element is a light emitting diode.

A drawback of SSL element-based lighting devices is that individual SSL elements have a much lower luminous output than e.g. incandescent, tungsten halogen or fluorescent light bulbs, such that it is necessary to include multiple SSL elements in a single light bulb to obtain the required luminous output levels.

However the foot print of the device, e.g. a light bulb, is a limiting factor in how many SSL elements can be integrated into a single device such as a GU10 or MR16 light bulb. In addition, it is far from straightforward to create a focused or collimated beam angle with such SSL element-based lighting devices, as the SSL elements tend to generate their output over wide angles, which may compromise the perceived quality of light produced by the SSL element-based lighting device.

A lighting device according to the opening paragraph is known from U.S. Pat. No. 8,083,379 B2, in which multiple LEDs are placed in the respective second focal points of ellipsoid mirrors. The first focal points of the ellipsoid mirrors coincide in a further concave mirror, which redirects light of a collimated nature through a central aperture in the array of ellipsoid mirrors. A drawback of this device is that the aperture has to be formed in the ellipsoid mirrors, which increases the complexity and cost of the lighting device. In addition, the design of this device does not facilitate an increase of the number of LEDs in the design, such that the luminous intensity of this lighting device is insufficient for certain application domains.

### SUMMARY OF THE INVENTION

The present invention seeks to provide a more cost-efficient lighting device capable of producing a collimated light output.

The present invention further seeks to provide a luminaire comprising such a lighting device.

According to a first aspect of the present invention, there is provided a lighting device comprising a reflective element comprising a reflective conical central section having a conic constant in the range of −0.7 to −1.3; and an annular array of reflective ellipsoid surfaces extending radially from said reflective conical central section, each reflective ellipsoid surface creating a first focal point inside the reflective conical central section and a second focal point; a solid state lighting element located at the second focal point of each of said reflective ellipsoid surfaces and arranged to emit light towards said reflective ellipsoid surface; and an exit window opposite said reflective conical central section.

The present inventors have realized that by providing a reflective element in which ellipsoid surfaces radially extend from a reflective conical central section including the first focal points of these ellipsoid surfaces, the exit window may be provided opposite the reflective element, thereby simplifying the manufacturing of the lighting device and reducing its manufacturing cost. In addition, by selecting the conic constant of the reflective conical central section in the range from −0.7 to −1.3, a collimated output may be generated in which the degree of collimation, i.e. the beam angle of the lighting device, may be controlled by the choice of the conic constant. It is noted that the conic constant is also known as the Schwarzschild constant.

The reflective conical central section typically has a convex surface, and in a preferred embodiment is a paraboloid having a conic constant of −1. It has been found that the combination of the radial array of ellipsoid reflective surfaces and a paraboloid reflective conical central section yields a lighting device having particularly good collimation, i.e. a particularly small beam angle.

In an embodiment, the solid state light elements at said second focal points are arranged on an annular carrier. This facilitates a good alignment of the solid state lighting elements with the first focal points of the respective reflective ellipsoid surfaces of the annular array.

The annular array may be an array of ellipsoid bodies, wherein each body comprises the reflective ellipsoid surface and a further reflective ellipsoid surface opposite the reflective ellipsoid surface, said further reflective ellipsoid surface creating a first focal point inside the reflective conical central section and a second focal point; the lighting device further comprising a solid state lighting element located at the second focal point of each of the further reflective ellipsoid surfaces and arranged to emit light towards said further reflective ellipsoid surface. This has the advantage that a higher number of solid state lighting elements can be integrated in the lighting device, thereby improving the intensity of the luminous output of the lighting device.

The solid state lighting elements at the second focal points of the reflective ellipsoid surfaces may be arranged on at least one first carrier and the solid state lighting elements at the second focal points of the further reflective ellipsoid surfaces may be arranged on at least one second carrier. By using different carriers, e.g. printed circuit boards, for the solid state lighting elements facing the reflective ellipsoid surfaces and the solid state lighting elements facing the further reflective ellipsoid surfaces, the carriers can be manufactured separately and independently, which reduces the manufacturing complexity of the lighting device.

In an embodiment, the at least one first carrier and the at least one second carrier are separated by a heat sink. Thus improves the dissipation of the heat generated by the solid state lighting elements, which therefore facilitates a higher density of solid state lighting elements in the lighting device without overheating risk, which further improves the intensity of the luminous output of the lighting device.

The ellipsoid bodies may be angled relative to a plane perpendicular to the symmetry axis of the reflective conical central section.

In an embodiment, the reflective element further comprises an annular array of further ellipsoid bodies angled relative to said plane, the ellipsoid bodies and further ellipsoid bodies being on opposite sides of said plane, each further ellipsoid body comprising a first reflective ellipsoid surface creating a first focal point inside said reflective conical central section and a second focal point; and a second reflective ellipsoid surface opposite the first reflective ellipsoid surface, said second reflective ellipsoid surface creating a first focal point inside said reflective conical central section and a second focal point; the lighting device further comprising a solid state lighting element located at the second focal point of each of said first reflective ellipsoid surfaces and arranged to emit light towards said first reflective ellipsoid surface; and a solid state lighting element located at the second focal point of each of said second reflective ellipsoid surfaces and arranged to emit light towards said second reflective ellipsoid surface. This achieves a lighting device producing a luminous output of excellent intensity.

Preferably, at least some of the first focal points coincide inside said reflective conical central section in order to improve the uniformity of the luminous output of the lighting device. More preferably, at least some of the first focal points coincide with a focal point of the reflective conical central section.

In an embodiment, the solid state lighting elements comprise solid state lighting elements having different colour points. This can be used to accurately tune the colour point of the lighting device, because excellent mixing of the luminous output of the various solid state lighting elements of the lighting device is achieved by the reflective element.

In an embodiment, the solid state lighting elements include a plurality of white light solid state lighting elements and a plurality of red light solid state lighting elements. This facilitates a lighting device having a high color rendering index (CRI) and without noticeable colour separation such as separate red spots being produced by the lighting device.

The lighting device advantageously may be a spot light bulb.

According to another aspect of the present invention, there is provided a luminaire comprising the lighting device according to an embodiment of the present invention. Such a luminaire may for instance be a holder of the lighting device or an apparatus into which the lighting device is integrated.

### BRIEF DESCRIPTION OF THE EMBODIMENTS

Embodiments of the invention are described in more detail and by way of non-limiting examples with reference to the accompanying drawings, wherein:

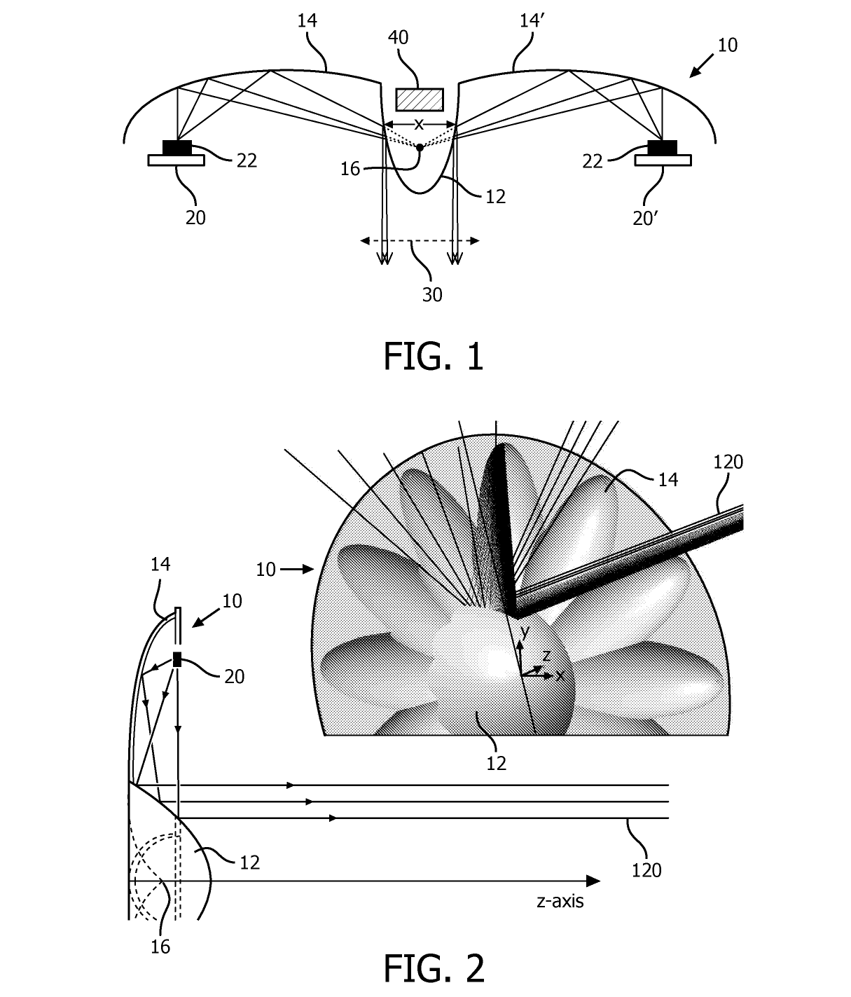

FIG. 1 schematically depicts a lighting device according to an embodiment of the present invention;

FIG. 2 schematically depicts an optical model of a lighting device according to an embodiment of the present invention;

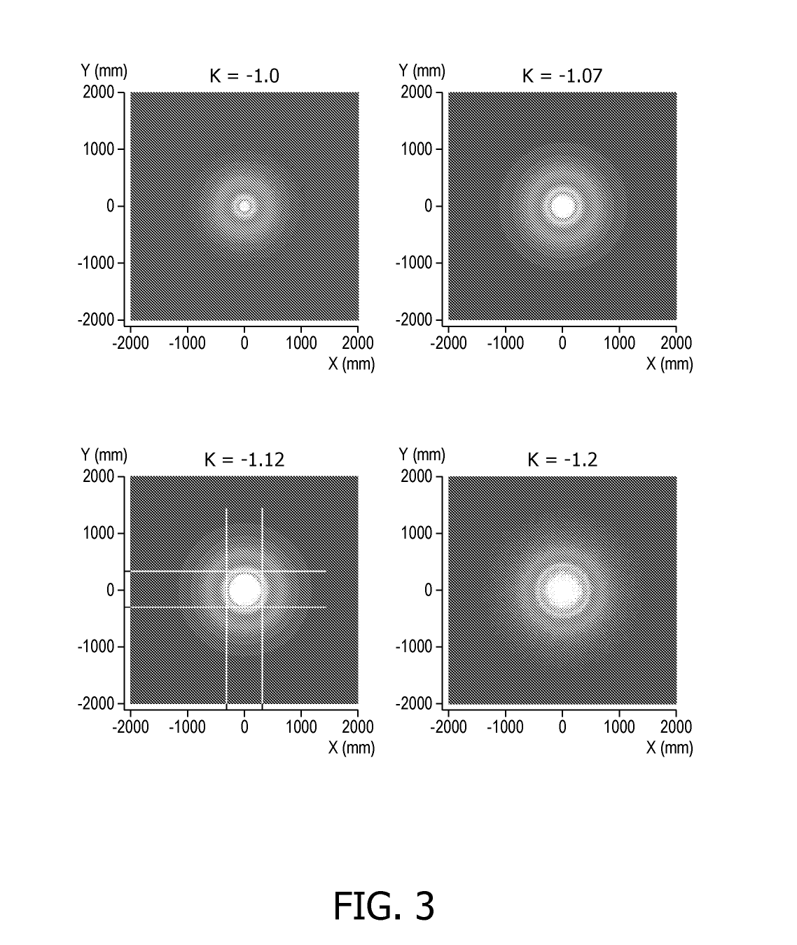

FIG. 3 schematically depicts luminous distribution patterns of lighting devices according to various embodiments of the present invention;

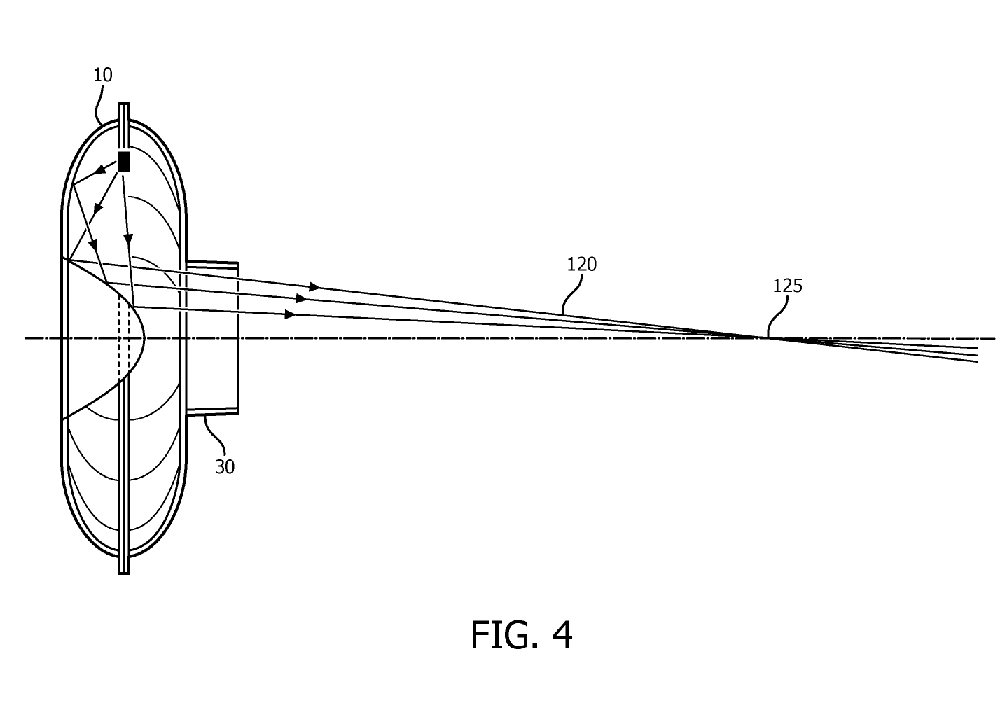

FIG. 4 schematically depicts an optical model of a lighting device according to another embodiment of the present invention;

FIG. 5 schematically depicts an aspect of a lighting device according to an embodiment of the present invention;

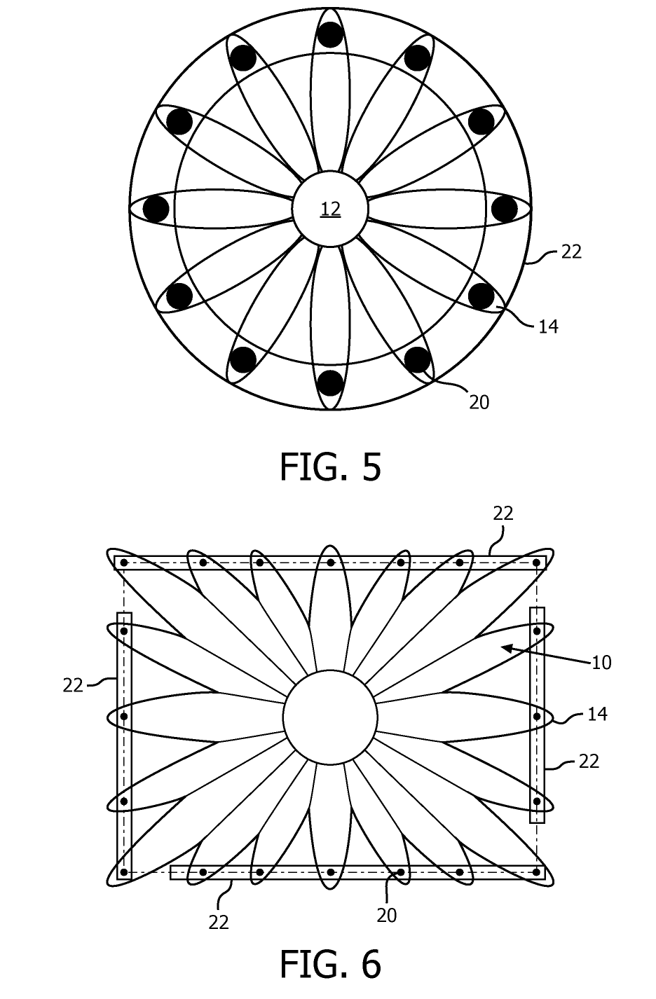

FIG. 6 schematically depicts an aspect of a lighting device according to another embodiment of the present invention;

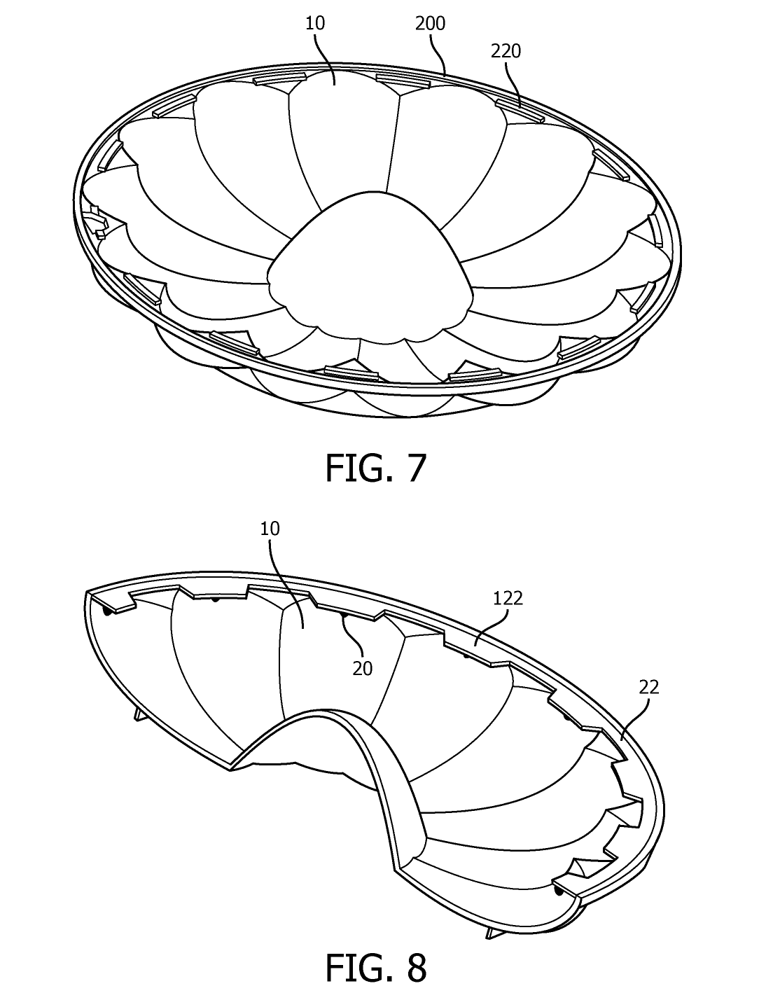

FIG. 7 schematically depicts another aspect of a lighting device according to an embodiment of the present invention;

FIG. 8 schematically depicts yet another aspect of a lighting device according to an embodiment of the present invention;

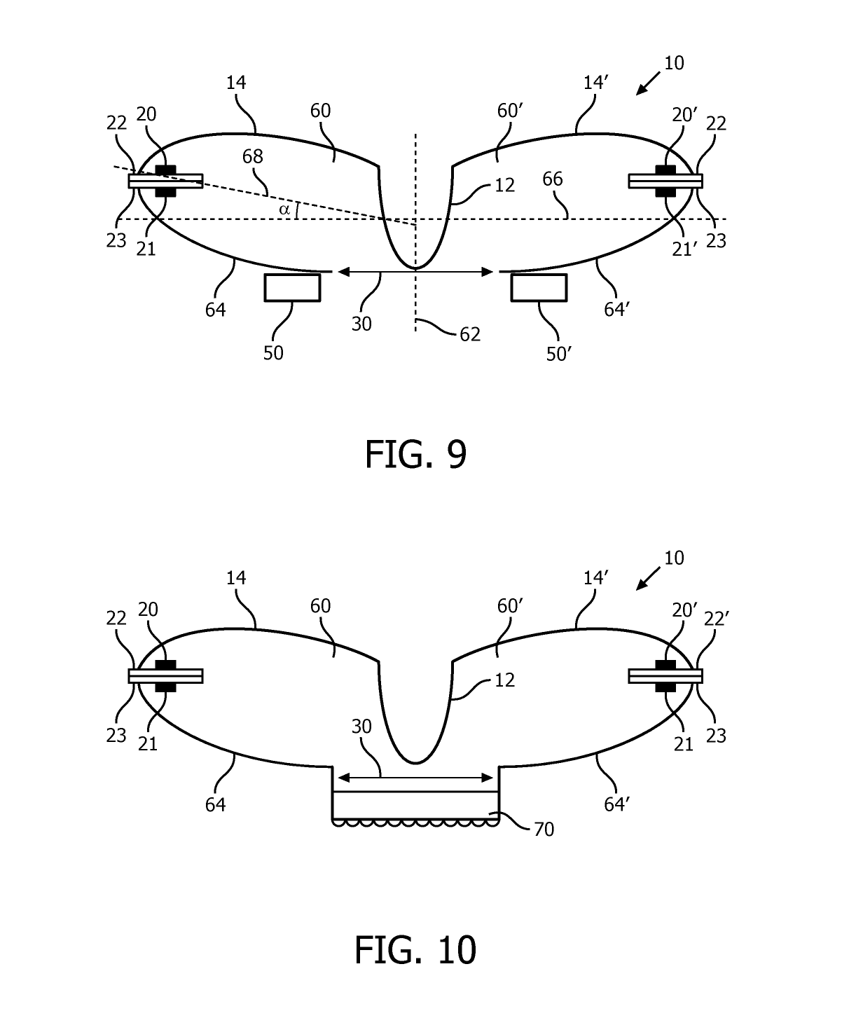

FIG. 9 schematically depicts a lighting device according to a further embodiment of the present invention;

FIG. 10 schematically depicts a lighting device according to yet another embodiment of the present invention;

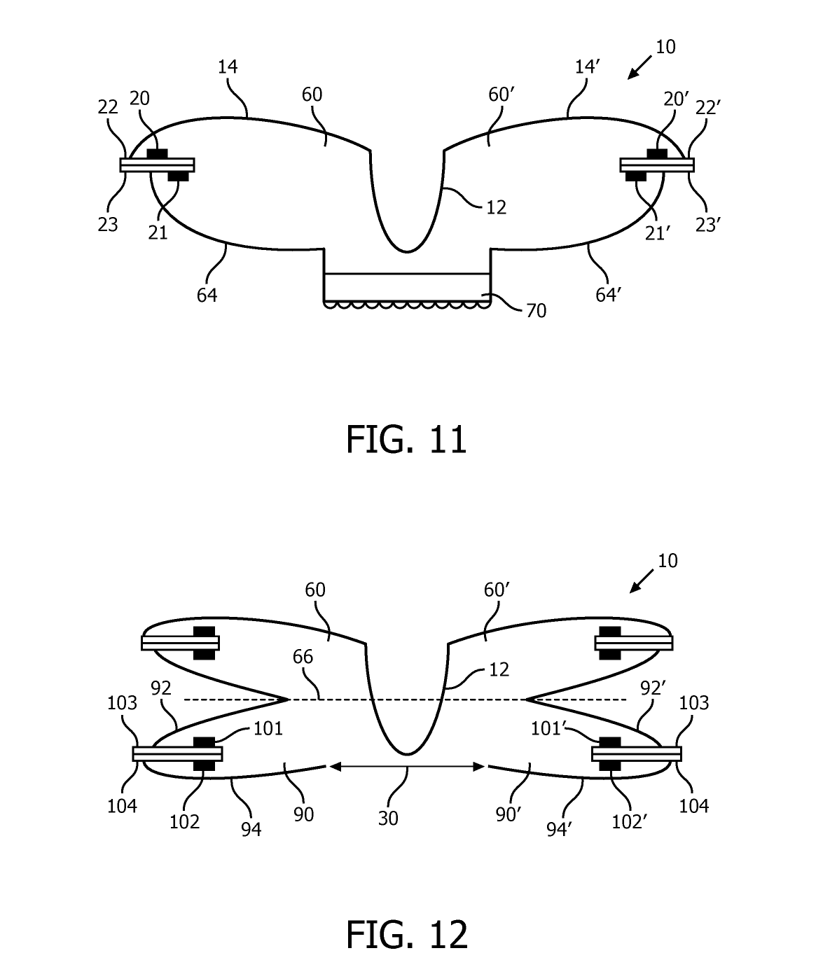

FIG. 11 schematically depicts a lighting device according to yet another embodiment of the present invention;

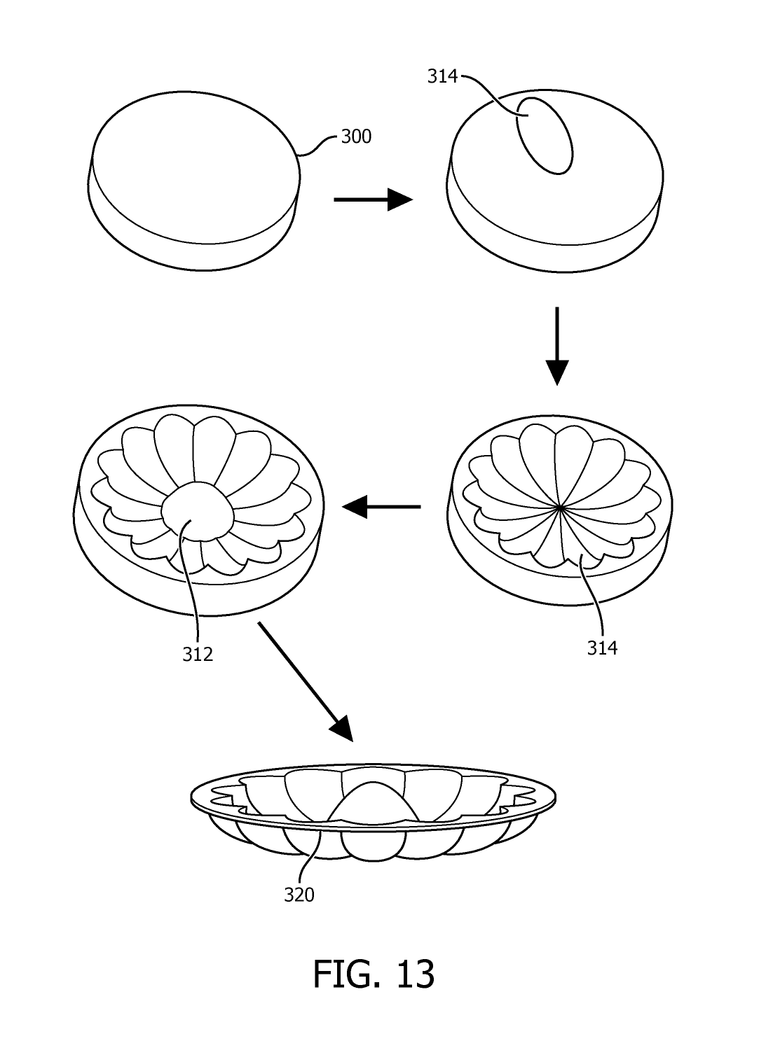

FIG. 12 schematically depicts a lighting device according to yet another embodiment of the present invention;

FIG. 13 schematically depicts an aspect of a method of manufacturing a lighting device according to the present invention;

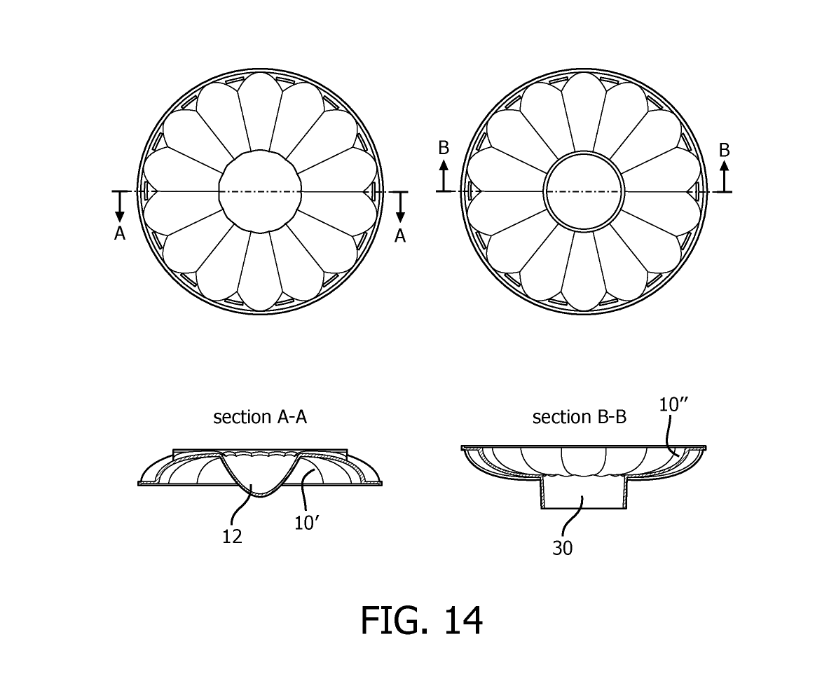

FIG. 14 schematically depicts parts of a lighting device manufactured in accordance with an embodiment of the method of manufacturing a lighting device according to the present invention; and

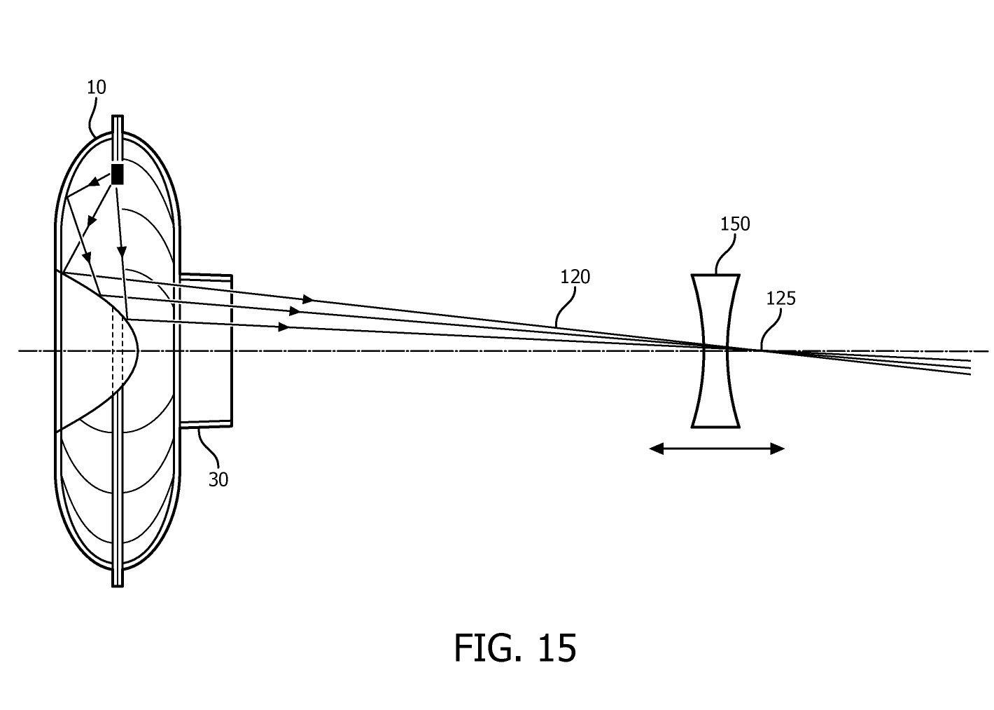

FIG. 15 schematically depicts an optical model of a lighting device according to an embodiment of the present invention.

### DETAILED DESCRIPTION OF THE DRAWINGS

It should be understood that the Figures are merely schematic and are not drawn to scale. It should also be understood that the same reference numerals are used throughout the Figures to indicate the same or similar parts.

FIG. 1 schematically depicts a cross-section of a lighting device according to an embodiment of the present invention. The lighting device comprises a reflective element 10 comprising a reflective convex conical central section 12 having a conic constant in the range of −0.7 to −1.3. The conic constant, which is also known as the Schwarzschild constant, defines the eccentricity of the conical central section 12. The conic constant may be expressed by the following formula in the x,y plane:

y²−2Rx+(K+1)x²=0

in which R is the radius of the curvature at x=0 and K is the conic constant.

The reflective element 10 further comprises an array of reflective ellipsoid surfaces that extend radially from said reflective conical central section 12. A first reflective ellipsoid surface 14 and a second reflective ellipsoid surface 14′ that each radially extend outwardly from the reflective conical central section 12 are shown in FIG. 1. The reflective conical central section 12 and the respective reflective ellipsoid surfaces 14, 14′ may be individually realized in any suitable reflective material, e.g. a polymer material such as polycarbonate covered with a reflective coating such as optical grade silver or aluminium. The polymer material may be a composite polymer material. For instance, the composite polymer material may include up to 20% by weight of glass fiber to improve the thermal characteristics of the material, e.g. reduce the thermal expansion coefficient of the material. Specifically, the polymer material may be polycarbonate optionally comprising up to 20% by weight of glass fiber.

The reflective ellipsoid surfaces 14, 14′ are arranged relative to the reflective conical central section 12 such that each reflective ellipsoid surface 14, 14′ creates a first focal point inside the reflective conical central section 12 and a second focal point outside the reflective conical central section 12.

In an embodiment, at least some of the first focal points of the respective reflective ellipsoid surfaces 14, 14′ may coincide in point 16 within the reflective conical central section 12. In an embodiment, point 16 is the focal point of the reflective conical central section 12. Preferably, all of the first focal points of the respective reflective ellipsoid surfaces 14, 14′ coincide in a focal point 16 of the reflective conical central section 12.

Respective solid state lighting (SSL) elements 20, 20′, which may be mounted on a single carrier 22 or on respective carriers 22, 22′, are placed at the various second focal points of the reflective ellipsoid surfaces 14, 14′ and are arranged such that each of the SSL elements 20, 20′ faces the reflective ellipsoid surface corresponding to the second focal point at which the solid state lighting element 20, 20′ is placed. In an embodiment, the SSL elements 20, 20′ are light-emitting diodes (LEDs).

Due to the ellipsoid nature of the reflective ellipsoid surfaces 14, 14′ and the placement of the SSL elements 20, 20′ at the respective second focal points of these reflective ellipsoid surfaces 14, 14′, the luminous output of the SSL elements 20, 20′ is redirected by the reflective ellipsoid surfaces 14, 14′ towards the respective first focal points of the reflective ellipsoid surfaces 14, 14′, which lie within the reflective conical central section 12. This ensures that substantially all of the luminous output of the SSL elements 20, 20′ is redirected onto the convex surface of the reflective conical central section 12. In other words, the reflective element 10 forms a confocal reflective element 10 in which the first reflection is provided by the reflective ellipsoid surfaces 14, 14′ and the second reflection is provided by the reflective conical central section 12.

Due to the conic constant in the range of −0.7 to −1.3 of the reflective conical central section 12, a highly collimated luminous output is generated by the reflective conical central section 12, as the reflective conical central section 12 redirects the luminous output of the SSL elements 20, 20′ through an exit window 30 of the lighting device, which exit window 30 is arranged opposite the reflective conical central section 12 of the reflective element 10. This is explained in more detail with the aid of FIG. 2 and FIG. 3.

FIG. 2 depicts an optical model of a lighting device of the present invention, in which the reflective element 10 comprises a convex conical central section 12 from which an array of ellipsoid reflective surfaces 14 radially extend outwardly, i.e. towards the perimeter of the lighting device, thus yielding a flower-shaped reflective element 10. SSL elements 20 are placed at each second focal point of the respective ellipsoid reflective surfaces 14 with the first focal points of the respective ellipsoid reflective surfaces 14 being located within the convex conical central section 12 as previously explained. In FIG. 2, it is shown by way of non-limiting example that the respective first focal points coincide in focal point 16, which may be the focal point of the conical central section 12 as previously explained.

The confocal arrangement of the reflective element 10 ensures that the luminous output 120 generated by the SSL elements 20 and 20′ exit the lighting device in a highly collimated fashion, i.e. substantially parallel to the z-axis shown in FIG. 2, which is the axis of symmetry of the convex conical central section 12 of the reflective element 10. In an embodiment, the convex conical central section 12 is a paraboloid, i.e. has a conic constant of −1, which yields particularly high collimation of the luminous output 120.

FIG. 3 depicts the beam profiles of the lighting device according to embodiments of the present invention as a function of the conic constant K of the convex conical central section 12 of the reflective element 10. Four beam profiles of lighting devices having a reflective element with a convex conical central section 12 having a conic constant of K=−1.0, K=−1.07, K=−1.12 and K=−1.20 respectively are shown. A convex conical central section 12 having a conic constant of −1 is a paraboloid, whereas a convex conical central section 12 having a conic constant of smaller than −1, e.g. K=−1.12, is a hyperboloid. FIG. 3 clearly depicts that the beam shape, e.g. the beam angle produced by the lighting device can be controlled by the selection of the appropriate conic constant for the convex conical central section 12.

FIG. 4 depicts an optical model of a lighting device of the present invention, in which the reflective element 10 comprises a convex conical central section 12 is a hyperboloid, i.e. has a conic constant smaller (i.e. more negative) than −1. It can be seen from FIG. 4 that by tuning the conic constant of the convex conical central section 12, the shape of the luminous output 120 of the lighting device that exits the exit window 30 can be controlled. Particularly, a convex conical central section 12 having a hyperboloid shape can be used to create a focussed luminous output 120, in which variations in the conic constant can be used to create the focus 125 of the luminous output 120 at different distances from the lighting device.

Upon returning to FIG. 1, it is furthermore noted that the width of the collimated luminous output 120 of the lighting device, i.e. the width of the light beam produced by the lighting device, may be controlled by the width of the cross-section marked ‘x’ in FIG. 1 of the conical central section 12 of the incident light reflected by the respective ellipsoid reflective surfaces 14, 14′. By increasing or reducing the width of this cross-section, the width of the collimated luminous output 120 is increased or reduced respectively. This property therefore may be exploited to create lighting devices having different beam widths.

The exit window 30 may comprise any suitable transparent material, e.g. glass or a transparent polymer material. The exit window 30 may comprise any suitable optical elements, e.g., a beam-shaping optical element such as a microlens array. In an embodiment, the optical element(s) can be a lens 150 or a group of lenses moveable along Z-axis as shown in FIG. 15, so as to realize a zooming effect of the lighting device. In other words, the output light beam angle can be changed by moving the optical element along Z-axis.

In an embodiment, the reflective conical central section 12 may be hollow. In this embodiment, a driver circuit 40 for driving the SSL elements 20, 20′ may be placed inside the reflective conical central section 12 in order to produce a very compact lighting device. This is particularly advantageous if the lighting device is a light bulb such as a spot light bulb. Non-limiting examples of such spot light bulbs include sizes such as E27, MR11, MR16, GU10, AR111, Par30 Par38, BR30, BR40, R20, R50, and so on.

In order to improve the scattering of incident light at the surface of the convex conical central section 12, the convex conical central section 12 may have a roughened surface.

In an embodiment, the various SSL elements 20, 20′ include SSL elements that produce different coloured light output, e.g. a mixture of red and white LEDs, a mixture of white light LEDs having different colour points and so on. This may be desirable to enhance the colour rendering index (CRI) and the red index of the lighting device. It has been found that the confocal reflective element 10 ensures excellent mixing of the luminous output of the SSL elements 20, 20′ at the various second focal points, such that the different coloured light generated at these second focal points is (near-)perfectly mixed when exiting the lighting device through the exit window 30.

For instance, where the lighting device comprises a combination of red LEDs and white LEDs, no noticeable colour separation, e.g. separate spots, can be detected in the luminous output 120 of the lighting device. Alternatively, a mixture of warm white LEDs and cold white LEDs may be used to achieve correlated colour temperature (CCT) dimming.

FIG. 5 schematically depicts an aspect of a lighting device according to an embodiment of the present invention in which the different SSL elements at the respective second focal points of the array of ellipsoid reflective surfaces 14 that radially extend outwardly from the conical central section 12 are placed on a single annular carrier 22, e.g. an annular printed circuit board. A particular advantage of this arrangement is that such an annular arrangement is a highly efficient configuration for heat distribution and dissipation, such that a high density of SSL elements 20 can be used without overheating the lighting device.

FIG. 6 schematically depicts an aspect of a lighting device according to an alternative embodiment of the present invention in which the different SSL elements at the respective second focal points of the array of ellipsoid reflective surfaces 14 that radially extend outwardly from the conical central section 12 on the four strips 22 of a rectangular carrier, e.g. an rectangular printed circuit board. This is an advantageous embodiment where cost considerations are important as such a rectangular carrier can be manufactured in a cost-effective manner. As can be seen in FIG. 6, the overall shape of the confocal reflective element 10 may be adjusted to accommodate it being combined with such a rectangular carrier.

FIG. 7 schematically depicts an aspect of a lighting device according to an embodiment of the present invention. In this embodiment, the lighting device comprises a holder 200 having guide elements 220 in which the reflective element 10 may be placed. The guide elements 220 ensure that the ellipsoid surfaces 14 are accurately aligned with the SSL elements 20 on the (annular) carrier 22 as shown in the cross-section of this lighting device in FIG. 8. In FIG. 8, the annular carrier 22 comprises a pattern of protrusions 122 each carrying a SSL element 20, wherein each of the protrusions 122 slots into the gap between neighbouring guide elements 220, thereby ensuring a highly accurate placement of the SSL elements 20 at the second focal points of the ellipsoid surfaces 14. In other words, the protrusions 122 protrude over the ellipsoid surfaces 14 such that the SSL elements 20 coincide with the second focal points of the ellipsoid surfaces. In this manner, an alignment of the SSL elements 20 with the second focal points can be achieved with an accuracy of as little as 0.2 mm deviation from the perfect alignment.

FIG. 9 schematically depicts a cross-section of a lighting device according to another embodiment of the present invention having an increased luminous output 120 compared to the lighting device of FIG. 1. In FIG. 9, the confocal reflective element 10 may comprise an array of ellipsoid bodies 60, 60′ that radially extend outwardly from the convex conical central section 12. As before, the convex conical central section 12 has a conic constant in the range of −0.7 to −1.3. Each of the reflective ellipsoid bodies 60, 60′ comprises a reflective ellipsoid surface 14, 14′ as shown in FIG. 1 as well as a further reflective ellipsoid surface 64, 64′ opposite the reflective ellipsoid surface 14, 14′. Each further reflective ellipsoid surface 64, 64′ is arranged to create a first focal point inside the reflective conical central section 12 and a second focal point outside the reflective conical central section 12.

The respective first focal points of the further reflective ellipsoid surface 64, 64′ may coincide inside the reflective conical central section 12. In an embodiment, the further reflective ellipsoid surfaces 64, 64′ are separated from each other by an exit window 30 opposite the reflective conical central section 12. The exit window 30 may be a circular exit window.

Further solid state lighting elements 21, 21′ are located at the second focal point of each of the further reflective ellipsoid surfaces and arranged to emit light towards said further reflective ellipsoid surface 64, 64′. In other words, the luminous surfaces of the further solid state lighting elements 21, 21′ face the further reflective ellipsoid surface 64, 64′. The respective solid state lighting elements 21, 21′ may be mounted on a single carrier 23, e.g. an annular PCB as shown in FIG. 5 and FIG. 8. As before, the further solid state lighting elements 21, 21′ may contain a mixture of different colour SSL elements, e.g. red and white LEDs, different colour temperature white LEDs and so on as previously explained. The annual carrier 22 may be separated from the further annual carrier 23 by a heat sink (not shown) to further improve the heat dissipation of the lighting device.

The one or more driver circuits of the SSL elements 20, 20′, 21 and 21 may be located in any suitable location, e.g. inside a hollow reflective conical central section 12 as previously explained, integrated in the carriers 22, 23 or placed underneath one or more of the reflective ellipsoid bodies 60, 60′. This last embodiment is shown in FIG. 9, which by way of non-limiting example shows two driver circuits 50, 50′ placed underneath the reflective ellipsoid bodies 60, 60′. It should be understood that the lighting device may include any suitable number of such a driver circuit 50, e.g. one or more of such circuits.

In FIG. 9, the position of the reflective ellipsoid bodies 60, 60′ is further defined by an angle α relative to the X-Y plane 66 of the lighting device. For the avoidance of doubt, the X-Y plane is the plane perpendicular to the axis of symmetry of the reflective conical central section 12, i.e. the Z-axis as shown in FIG. 2. The angle α is defined as the angle between the central plane 68 between the reflective ellipsoid surface 14 and the further reflective ellipsoid surface 64 (or of the reflective ellipsoid surface 14′ and the further reflective ellipsoid surface 64′) and the X-Y plane 66.

In an embodiment (not shown), α=0°, in which case the central plane 68 coincides with the X-Y plane 66. Alternative α≠0°, in which case the reflective ellipsoid bodies 60, 60′ are tilted out of the X-Y plane 66, such that the respective first focal points of the reflective ellipsoid surfaces 14, 14′ and the further reflective ellipsoid surfaces 64, 64′ are translated along the Z-axis in the direction of the vertex of the reflective conical central section 12. This effectively reduces the beam width of the luminous output 120, which for instance may reduce spatial colour separation and therefore improves the perception of colour mixing by the reflective element 10 of the lighting device. In an embodiment, the angle α may be chosen in the range of 1-10°. Although higher angles are feasible, it has been found that the luminous output of the lighting device is reduced at these higher angles due to absorption of the generated light by the annular carriers 22, 23.

FIG. 10 schematically depicts a cross-section of a lighting device according to another embodiment of the present invention. The embodiment as shown in FIG. 10 is identical to the embodiment shown in FIG. 9 and its detailed description apart from the fact that the exit window 30 further comprises a beam shaping element 70 in the form of a microlens array to further improve the homogeneity of the luminous output 120 of the lighting device.

In FIG. 9 and FIG. 10, the reflective ellipsoid surfaces 14, 14′ and the further reflective ellipsoid surfaces 64, 64′ meet at the outermost point of the reflective ellipsoid bodies 60, 60′. This, however, is by way of non-limiting example only. FIG. 11 schematically depicts a cross-section of a lighting device according to yet another embodiment of the present invention. The lighting device as shown in FIG. 11 is identical to the lighting device shown in FIG. 9 or 10 and their detailed descriptions apart from that the further reflective ellipsoid surfaces 64, 64′ do not radially extend to the same outward point as the reflective ellipsoid surfaces 14, 14′; i.e. the reflective ellipsoid surfaces 14, 14′ and the further reflective ellipsoid surfaces 64, 64′ do not meet at the outermost point of the reflective ellipsoid bodies 60, 60′. Instead, the further reflective ellipsoid surfaces 64, 64′ are smaller than the reflective ellipsoid surfaces 14, 14′ in the sense that the most outward point of the further reflective ellipsoid surfaces 64, 64′ is closer to the z-axis than the most outward point of the reflective ellipsoid surfaces 14, 14′.

Embodiments of the reflective element 10 of the lighting device of the present invention is not limited to a single array of reflective ellipsoid bodies 60, 60′ such as shown by way of non-limiting example in FIG. 6-8. FIG. 12 schematically depicts a cross-section of a lighting device according to an embodiment of the present invention in which the reflective element 10 comprises an array of reflective ellipsoid bodies 60, 60′ above the X-Y plane 66 and a further array of ellipsoid bodies 90, 90′ below the X-Y plane 66. The ellipsoid bodies 90, 90′ of the further array each comprise a first reflective ellipsoid surface 92, 92′ creating a first focal point within the reflective conical central section 12 and a second focal point at which a SSL element 101, 101′ is located. The ellipsoid bodies 90, 90′ of the further array additionally each comprise a second reflective ellipsoid surface 94, 94′ opposite the first reflective ellipsoid surface that creates a first focal point inside said reflective conical central section 12 and a second focal point at which a SSL element 102, 102′ is located.

As before, the SSL elements 101, 101′ are arranged to direct their luminous output towards the first reflective ellipsoid surfaces 92, 92′ respectively, i.e. have their luminous surfaces facing the first reflective ellipsoid surface 92, 92′, whereas the SSL elements 101, 101′ are arranged to direct their luminous output towards the second reflective ellipsoid surfaces 94, 94′ respectively, i.e. have their luminous surfaces facing the second reflective ellipsoid surface 94, 94′. The solid state lighting elements 101 and 101′ may be mounted on a single carrier 103, e.g. an annular PCB as shown in FIG. 5 and FIG. 8. The solid state lighting elements 102 and 102′ may be mounted on a separate annular carrier 104, e.g. an annular PCB as shown in FIG. 5 and FIG. 8. The carriers 103 and 104 may be separated by a heat sink (not shown) to improve the heat dissipation of the carriers.

As before, the SSL elements 101, 101′ and the SSL elements 102, 102′ may comprise a mixture of different colour SSL elements, e.g. white LEDs having different colour temperatures, white and red LEDs and so on. Further optical elements, e.g. beam shaping elements such as the micro-lens array 70 shown in FIG. 7 may also be included in the lighting device of FIG. 9. It will be understood that an increase of the number of reflective ellipsoid bodies in the design of the reflective element 10 allows for a further increase in the number of SSL elements in the lighting device, which further increases the intensity of the luminous output 120 of the lighting device such that an even brighter lighting device may be provided.

For the avoidance of doubt, it is noted that in FIG. 1, the reflective element 10 of the lighting device of the present invention has an annular array of first reflective surfaces 14 and 14′ that generate a first focal point within the reflective conical central section 12, which first focal points preferably coincide with each other, as previously explained. The first reflective surfaces 14 and 14′ further generate a second focal point in which a first group of SSL elements 20, 20′ are located.

In FIG. 9-11, the reflective element 10 of the lighting device of the present invention has a first annular array of first reflective bodies 60, 60′. The first reflective bodies include the first reflective surfaces 14 and 14′ of the reflective element 10 of FIG. 1 and further include second reflective surfaces 64 and 64′ that generate a third focal point within the reflective conical central section 12, which third focal points preferably coincide with each other, as previously explained. The second reflective surfaces 64 and 64′ further generate a fourth focal point at which a second group of SSL elements 21, 21′ are located.

In FIG. 12, the reflective element 10 of the lighting device of the present invention comprises the first annular array of first reflective bodies 60, 60′ and further comprises a second annular array of second reflective bodies 90, 90′. The second reflective bodies 90, 90′ include a third reflective surface 92 and 92′ that generate a fifth focal point within the reflective conical central section 12, which fifth focal points preferably coincide with each other, as previously explained.

The third reflective surfaces 92 and 92′ further generate a sixth focal point at which a third group of SSL elements 101, 101′ are located. The second reflective bodies 90, 90′ further include a fourth reflective surface 94 and 94′ that generate a seventh focal point within the reflective conical central section 12, which seventh focal points preferably coincide with each other, as previously explained. The fourth reflective surfaces 94 and 94′ further generate an eighth focal point at which a fourth group of SSL elements 102, 102′ are located.

The first, third, fifth and seventh focal points within the reflective conical central section 12 preferably coincide with each other or are at least spatially separated from each other by as small as possible distance to optimize the color mixing characteristics of the lighting device. Insofar as is practicable, the first, third, fifth and seventh focal points within the reflective conical central section 12 preferably coincide with the focal point 16, e.g. the focal point of the reflective conical central section 12, or are located as close as possible to the focal point 16 to optimize the collimation of the luminous output 120 of the lighting device.

In an embodiment, the first group of SSL elements 20, 20′ may comprise the same colour or different colour SSL elements as previously explained.

In an embodiment, the second group of SSL elements 21, 21′ may comprise the same colour or different colour SSL elements as previously explained. In addition, the colours of the second group of SSL elements 21, 21′ may be the same as or different to the colours of the first group of SSL elements 20, 20′.

In an embodiment, the third group of SSL elements 101, 101′ may comprise the same colour or different colour SSL elements as previously explained. In addition, the colours of the third group of SSL elements 101, 101′ may be the same as or different to the colours of the second group of SSL elements 21, 21′, and/or may be the same as or different to the colours of the first group of SSL elements 20, 20′.

In an embodiment, the fourth group of SSL elements 102, 102′ may comprise the same colour or different colour SSL elements as previously explained. In addition, the colours of the fourth group of SSL elements 102, 102′ may be the same as or different to the colours of the third group of SSL elements 101, 101′, and/or may be the same as or different to the colours of the second group of SSL elements 21, 21′, and/or may be the same as or different to the colours of the first group of SSL elements 20, 20′.

The reflective element 10 may be manufactured in any suitable manner. In a particularly suitable embodiment, the reflective element 10 is made using a mould, which may be formed in the following manner as shown in FIG. 13. The method may commence with the provision of a cylindrical slab 300 of a raw material, in which a radial pattern 314 of ellipsoid surfaces is formed, e.g. by scooping out the raw material. Next, the reflective conical central section 312 is placed in the centre of the resultant structure and affixed, e.g. adhered, to the resultant structure to produce a mould 320. The mould 320 may be used in a subsequent shelling process to form the reflective element 10, e.g. by forming a polycarbonate shell optionally reinforced with glass fiber as previously explained and subsequently coated with a reflective material to yield the reflective element 10. Suitable materials include optical grade aluminium, which yields a reflective element 10 with a reflectance of around 87% and optical grade silver, which yields a reflective element 10 with a reflectance of around 93%.

More complex embodiments of the reflective element 10 may be created by separately forming the opposite reflective surfaces using separate moulds and affixing, e.g. adhering or gluing, the separately formed opposite reflective surfaces to form the final structure of the reflective element 10. A non-limiting example of such separate components is shown in FIG. 14, showing a first part 10′ of a reflective element 10 including the central reflective element 12 and a second part 10″ of a reflective element 10 including an exit window 30. The opposite parts 10′ and 10″ may be combined to form a reflective element 10 according to an embodiment of the present invention.

For instance, the first part 10′ may be placed in a holder 200 as shown in FIG. 7, after which the annular carrier for the first part and the annular carrier for the second part 10″ are placed in the holder 200. The lighting device may be completed by the adhesion of the second part 10″ to the resultant structure.

The lighting device according to embodiments of the present invention may be a light bulb, more preferably a spot light bulb. The lighting device according to embodiments of the present invention may be advantageously included in a luminaire such as a holder of the lighting device, e.g. a ceiling light fitting, or an apparatus into which the lighting device is integrated, e.g. a cooker hood or the like.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements. In the device claim enumerating several means, several of these means can be embodied by one and the same item of hardware. The mere fact that certain measures are recited in mutually different dependent claims does not indicate that a combination of these measures cannot be used to advantage.

1. A lighting device comprising:
a reflective element comprising:
a reflective conical central section having a conic constant in the range of −0.7 to −1.3, and a symmetry axis; and
an annular array of reflective ellipsoid surfaces extending radially from said reflective conical central section, each reflective ellipsoid surface creating a first focal point inside the reflective conical central section and a second focal point;
a solid state lighting element located at the second focal point of each of said reflective ellipsoid surfaces and arranged to emit light towards said reflective ellipsoid surface; and
an exit window opposite said reflective conical central section;
wherein the reflective conical central section has a convex surface.

2. The lighting device of claim 1, wherein the exit window comprises an optical element movable along the symmetry axis of the reflective conical central section.

3. The lighting device of claim 1, wherein the central conical section is a paraboloid having a conic constant of −1.

4. The lighting device of claim 1, wherein the solid state light elements at said second focal points are arranged on an annular carrier.

5. The lighting device of claim 1, wherein the annular array is an array of ellipsoid bodies each body comprising:
the reflective ellipsoid surface; and
a further reflective ellipsoid surface opposite the reflective ellipsoid surface, said further reflective ellipsoid surface creating a first focal point inside the reflective conical central section and a second focal point;
the lighting device further comprising a solid state lighting element located at the second focal point of each of the further reflective ellipsoid surfaces and arranged to emit light towards said further reflective ellipsoid surface.

6. The lighting device of claim 5, wherein the solid state lighting elements at the second focal points of the reflective ellipsoid surfaces are arranged on at least one first carrier and the solid state lighting elements at the second focal points of the further reflective ellipsoid surfaces are arranged on at least one second carrier.

7. The lighting device of claim 6, wherein the at least one first carrier and the at least one second carrier are separated by a heat sink.

8. The lighting device of claim 1, wherein said ellipsoid bodies are angled relative to a plane perpendicular to the symmetry axis of the reflective conical central section.

9. The lighting device of claim 8, wherein the reflective element further comprises an annular array of further ellipsoid bodies angled relative to said plane, the ellipsoid bodies and further ellipsoid bodies being on opposite sides of said plane, each further ellipsoid body comprising:
a first reflective ellipsoid surface creating a first focal point inside said reflective conical central section and a second focal point; and
a second reflective ellipsoid surface opposite the first reflective ellipsoid surface, said second reflective ellipsoid surface creating a first focal point inside said reflective conical central section and a second focal point;
the lighting device further comprising:
a solid state lighting element located at the second focal point of each of said first reflective ellipsoid surfaces and arranged to emit light towards said first reflective ellipsoid surface; and
a solid state lighting element located at the second focal point of each of said second reflective ellipsoid surfaces and arranged to emit light towards said second reflective ellipsoid surface.

10. The lighting device of claim 1, wherein at least some of the first focal points coincide inside said reflective conical central section.

11. The lighting device of claim 10, wherein at least some of the first focal points coincide with a focal point of the reflective conical central section.

12. The lighting device of claim 1, wherein the solid state lighting elements comprise solid state lighting elements having different colour points.

13. The lighting device of claim 1, wherein the solid state lighting elements include a plurality of white light solid state lighting elements and a plurality of red light solid state lighting elements.

14. The lighting device of claim 1, wherein the lighting device is a spot light bulb.

15. A luminaire comprising the lighting device of claim 1.
